(19) United States
(12) Patent Application Publication
(10) Pub. No.: US 2019/0188817 A1
(43) Pub. Date: Jun. 20, 2019

(54) MANAGEMENT APPARATUS FOR VALET PARKING SERVICE, USE SUPPORT METHOD FOR VALET PARKING SERVICE, AND NON-TRANSITORY COMPUTER-READABLE RECORDING MEDIUM INCLUDING PROGRAM RECORDED THEREON

(71) Applicant: Toyota Jidosha Kabushiki Kaisha, Toyota-shi (JP)

(72) Inventors: Tohru Yanagida, Nagoya-shi (JP); Chikage Kubo, Chofu-shi (JP); Ai Fujimura, Toyota-shi (JP); Shunsuke Noda, Kakamigahara-shi (JP); Satoshi Usui, Nagoya-shi (JP)

(73) Assignee: Toyota Jidosha Kabushiki Kaisha, Toyota-shi (JP)

(21) Appl. No.: 16/195,097

(22) Filed: Nov. 19, 2018

(30) Foreign Application Priority Data
Dec. 15, 2017 (JP) 2017-241124

(51) Int. Cl. G06Q 50/30; G06Q 10/06

(52) U.S. Cl. CPC G06Q 50/30; G06Q 10/06311

(57) ABSTRACT

A management apparatus for a valet parking service that a valet driver parks a vehicle of a service user in place of the service user includes a transmission unit including a communication unit and a processor. The transmission unit is configured to transmit information, indicating a plurality of valet driver candidates available to park the vehicle in place of the service user, to a terminal of the service user together with information indicating an attribute of each of the plurality of the valet driver candidates.

### INCORPORATION BY REFERENCE

The disclosure of Japanese Patent Application No. 2017-241124 filed on Dec. 15, 2017 including the specification, drawings and abstract is incorporated herein by reference in its entirety.

### BACKGROUND

### 1. Technical Field

The present disclosure relates to a management apparatus for a valet parking service, a use support method for a valet parking service, and a non-transitory computer-readable recording medium including a program recorded on the recording medium.

### 2. Description of Related Art

In a situation in which a person visits a predetermined destination (such as a shop, a shopping mall, and an event site) by driving a vehicle for shopping participation in an event, appreciation of an event, or the like, a parking lot in the destination may be full. When the parking lot is full, a driver may wait in a queue of vehicles for parking while driving the vehicle until a vacant parking space (referred to as vacant space) is available. Even when a driver looks for a vacant space while driving slowly in a parking lot, the driver may not easily find a vacant space. The driver may also miss a vacant space, and another vehicle may be parked in the vacant space in advance. In some cases, a driver may give up using a parking lot in a destination, and park the vehicle in another parking lot near or around the destination. Not a small number of drivers believe that such a search for a parking lot or parking space and a wait for a vacant space are a waste of time. For this reason, a valet parking service for parking a vehicle in place of a regular driver is conceivable. A service user (for example, a regular driver) stops a vehicle in a pickup place. A valet driver goes to the pickup place of the vehicle, temporarily takes charge of the vehicle, moves the vehicle to a parking lot, and parks the vehicle.

As for a chauffeur service for a vehicle, there is a management server (see, for example, Japanese Unexamined Patent Application Publication No. 2013-156735 (JP 2013-156735 A)). The management server selects chauffeur service providers in ascending order of possible arrival time from among chauffeur service providers from which a possible arrival time has been received within a predetermined time from terminals of the chauffeur service providers. Then, the management server transmits the possible arrival time of each of the selected chauffeur service providers to a user terminal. Some vehicle dispatch systems for taxi service providers and chauffeur service providers vary a registration fee in accordance with a rating of a driver or vehicle (see, for example, Japanese Unexamined Patent Application Publication No. 2004-280536 (JP 2004-280536 A)).

### SUMMARY

In order to promote and spread the use of a new service called valet parking service, it is desired to provide a sense of safety and a sense of satisfaction to a service user of the valet parking service and to make the service user easier to submit a request for the valet parking service irrespective of whether the service user is a first-time user or a repeat user. It is presumable that a service user is highly concerned about who is a valet driver that drives a vehicle in place of the service user irrespective of whether the service user is a first-time user or a repeat user. With a valet parking service, a service user does not ride on a vehicle with a valet driver, and the valet driver drives the vehicle beyond service user's view. Therefore, the service user presumably wants to properly submit a request for a valet parking service after the service user holds that this person is safe and satisfactory.

The present disclosure provides a management apparatus for a valet parking service, a use support method for a valet parking service, and a non-transitory computer-readable recording medium including a program recorded on the recording medium, which are able to provide a sense of safety and a sense of satisfaction to a service user with a valet parking service.

A main point of the disclosure is to, in a valet parking service that a valet driver parks a vehicle of a service user in place of the service user, transmit a plurality of valet driver candidates available to park the vehicle in place of the service user to the service user together with information indicating an attribute of each of the plurality of the valet driver candidates.

An aspect of the disclosure provides a management apparatus for a valet parking service. The management apparatus manages a valet parking service that a valet driver parks a vehicle of a service user in place of the service user. The management apparatus includes a transmission unit including a communication unit and a processor. The transmission unit is configured to transmit information, indicating a plurality of valet driver candidates available to park the vehicle in place of the service user, to a terminal of the service user together with information indicating an attribute of each of the valet driver candidates. In the management apparatus, the processor may be configured to, when the processor has received information indicating a valet driver candidate selected by the service user from among the plurality of valet driver candidates, determine the valet driver candidate selected by the service user as a valet driver to whom a request to park the vehicle in place of the service user is submitted.

With the management apparatus according to the above aspect, a plurality of valet driver candidates is provided to a service user together with information indicating an attribute of each of the valet driver candidate. Thus, it is possible to provide a sense of safety and a sense of satisfaction to the service user. The service user selects a valet driver having an attribute desired by the service user by referring to the information indicating the attributes as a valet driver to whom a request to park the vehicle in place of the service user is submitted. The management apparatus determines the selected valet driver as a valet driver to whom a request to park the vehicle in place of the service user is submitted. Thus, since the vehicle is parked by a valet driver desired by a service user in place of the service user, it is possible to provide a sense of safety and a sense of satisfaction to the service user. By providing a sense of safety and a sense of satisfaction, it is possible to make a service user easy to make a decision to use the service. That is, usability is improved. When a service user has already concluded a contract for the use of the service, it is possible to make the service user recognize that the vehicle is parked by a valet driver selected by the service user in place of the service user, so it is also possible to provide a sense of safety and a sense of satisfaction to the service user. As described above, a valet driver may be selected by a service user either before a contract concerned with the use of a valet parking service or after the contract. In the specification, the term “service user” includes both a person who intends to use a valet parking service and a person who actually receives the service after conclusion of the contract.

In the management apparatus according to the aspect of the disclosure, the processor may be configured to extract the plurality of valet driver candidates based on any one of a pickup place of the vehicle and a current location of the vehicle. With this configuration, it is possible to select a valet driver near a pickup place or a current location of the vehicle or a valet driver who is able to early reach the pickup place or the current location of the vehicle, as a plurality of candidates and provide the candidates to the service user. Thus, it is possible to make a service user expect a smooth pickup of the vehicle, so it is possible to provide a sense of safety and a sense of satisfaction to the service user.

In the management apparatus according to the aspect of the disclosure, the processor may be configured to extract valet drivers each having an attribute that matches with an attribute desired by the service user, as the plurality of valet driver candidates. Since valet drivers each having an attribute that matches with an attribute desired by the service user are extracted as candidates, the service user is allowed to select a valet driver, to whom a request is submitted, by carefully looking over the candidates. Thus, it is possible to further improve usability.

The attribute may be any information as long as the information can be a reference at the time when the user considers a valet driver to whom a request is submitted. Examples of the attribute include a pickup place of a vehicle, a current location of a vehicle, a current location of a valet driver, a distance between a valet driver and a pickup place or current location of a vehicle, a location area of a valet driver, a time required for a valet driver to reach a pickup place, an age of a valet driver, sex of a valet driver, an appearance of a valet driver, a background (birthplace, hobby, professional skill, academic background, business career, qualification, driving experience, and the like) of a valet driver, whether a valet driver smokes, a service fee of a valet driver, word-of-mouth (a rumor about a reputation of things) count of a valet driver, a rating of a valet driver, an insurance coverage amount (upper limit coverable amount at the time of an accident) of a valet driver, a birthplace of a valet driver, a hobby of a valet driver, and whether a valet driver has a gold driver's license. However, the attribute is not limited to these pieces of information. For example, the attribute may be selected at least one that is selected from among sex of a valet driver, an age of a valet driver, whether a valet driver smokes, an appearance of a valet driver, a background of a valet driver, a time required for a valet driver to reach a pickup place, and a service fee of a valet driver.

Another aspect of the disclosure provides a use support method for a valet parking service, which uses a valet parking service that a valet driver parks a vehicle of a service user in place of the service user. The use support method includes transmitting information, indicating a plurality of valet driver candidates available to park the vehicle in place of the service user, to a terminal of the service user together with information indicating an attribute of each of the plurality of the valet driver candidates. The use support method may further include, when information indicating a valet driver candidate selected by the service user from among the plurality of valet driver candidates has been received, determining the valet driver candidate selected by the service user as a valet driver to whom a request to park the vehicle in place of the service user is submitted.

Further another aspect of the disclosure provides a non-transitory computer-readable recording medium including a program recorded on the recording medium. The program causes a computer of a management apparatus for a valet parking service that a valet driver parks a vehicle of a service user in place of the service user, to execute instructions for transmitting information, indicating a plurality of valet driver candidates available to park the vehicle in place of the service user, to a terminal of the service user together with information indicating an attribute of each of the plurality of the valet driver candidates. The program may further cause the computer to execute instructions for, when information indicating a valet driver candidate selected by the service user from among the plurality of valet driver candidates has been received, determining the valet driver candidate selected by the service user as a valet driver to whom a request to park the vehicle in place of the service user is submitted.

According to the aspects of the disclosure, it is possible to provide a sense of safety and a sense of satisfaction to a service user with a valet parking service.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic diagram of a system for a valet parking service according to an embodiment;

FIG. 2 shows an example of the configuration of a terminal that is usable as a service user terminal or a valet driver terminal;

FIG. 3 shows an example of the configuration of a management apparatus;

FIG. 4 shows an example of the data structure of a user database (user DB);

FIG. 5 shows an example of the data structure of a valet driver database (valet driver DB);

FIG. 6 shows an example of the data structure of a parking lot database (parking lot DB);

FIG. 7 is a flowchart that shows the flow of a process at the time of user registration in the user terminal;

FIG. 8 shows an example of a new registration page;

FIG. 9 is a flowchart that shows the flow of a process at the time of user registration in the management apparatus;

FIG. 10 is a flowchart that shows an example of a process in the management apparatus;

FIG. 11 is a flowchart that shows an example of a process in the user terminal;

FIG. 12 shows an example of a use application page;

FIG. 13 shows the schematic configuration of a lock/unlock system including a key unit;

FIG. 14 schematically shows an example of the configuration of the key unit, mobile terminal, a lock/unlock device, and server device, shown in FIG. 13; and

FIG. 15 shows an alternative embodiment of the management apparatus.

### DETAILED DESCRIPTION OF EMBODIMENTS

Hereinafter, a management apparatus for a valet parking service, a use support method for a valet parking service, and a non-transitory computer-readable recording medium including a program recorded on the recording medium, according to an embodiment, will be described with reference to the accompanying drawings. The configuration of the embodiment is illustrative. The disclosure is not limited to the configuration of the embodiment.

### System Configuration

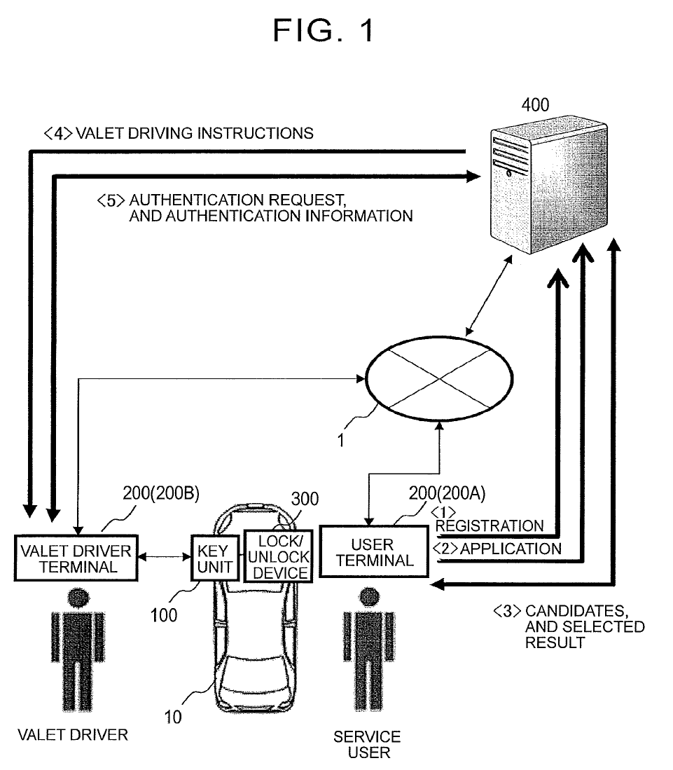

FIG. 1 is a schematic diagram of a system for a valet parking service according to the embodiment. As shown in FIG. 1, the system includes a user terminal 200A, a valet driver terminal 200B, and a management apparatus 400, which are connected to a network 1. The network 1 is, for example, a communication network, such as the Internet. A wide area network (WAN) or another communication network may be employed as the network 1. The network 1 may include a cellular network, such as long term evolution (LTE), and a wireless network, such as a wireless local area network (LAN) including Wi-Fi.

The user terminal 200A is a terminal device of a service user who uses the valet parking service. The user terminal 200A can be regarded as a terminal of a service user. The user terminal 200A may be a feature phone, a smart device, such as a smartphone and a tablet terminal, a personal digital assistant (PDA), or a mobile terminal (a portable communication terminal), such as a wearable computer. The user terminal 200A may be an onboard terminal provided in a vehicle 10 of a service user.

The valet driver terminal 200B is a terminal device of a valet driver who parks the vehicle 10 of the service user in place of the service user. The valet driver terminal 200B can be regarded as a terminal of a valet driver. The valet driver terminal 200B as well as the user terminal 200A may be a mobile terminal or an onboard terminal. In short, the user terminal 200A and the valet driver terminal 200B should be movable and communicable with the management apparatus 400 via the network 1. As long as the user terminal 200A and the valet driver terminal 200B are movable and communicable with the management apparatus 400 via the network 1, the user terminal 200A and the valet driver terminal 200B may be devices other than the above-described mobile terminal or onboard terminal. In the present embodiment, the case where the user terminal 200A and the valet driver terminal 200B are mobile terminals will be described as an example. When the user terminal 200A and the valet driver terminal 200B are referred to as mobile terminals without being distinguished from each other, the wording “mobile terminal 200” is used.

The vehicle 10 includes a smart key system. The smart key system includes a lock/unlock device 300 and a key unit 100. A unique ID is assigned to a mobile device (called electronic key) that carries out wireless communication with the vehicle 10. The lock/unlock device 300 enables door unlocking and engine start when the ID obtained through communication matches with an ID registered in the vehicle 10 in advance. The key unit 100 is a device that enables locking and unlocking of the vehicle 10 with the use of the mobile terminal 200 instead of the electronic key without adapting the vehicle 10. The key unit 100 is disposed at a predetermined position (for example, a glove box, or the like) in the vehicle 10. The key unit 100 gains power from a battery or secondary battery of the vehicle 10, and works as an electronic key to enable, for example, door unlocking, engine start, and the like, when the key unit 100 has acquired enabling data for enabling the operation of the vehicle 10 (data for temporarily enabling the operation of the vehicle 10, such as unlocking of the vehicle 10 and engine start of the vehicle 10) from the mobile terminal 200. The enabling data may be data that is executable by a computer (that is, a program), or may be data that is not executable by a computer. The enabling data may be data for proving that a person is allowed to operate the vehicle 10, data for activating a device or program that is used to operate the vehicle 10, a program that is used to operate the vehicle 10, or other data. In the present embodiment, the case where the enabling data is authentication information that the key unit 100 uses to authenticate the valet driver terminal 200B and that places the vehicle 10 in a state where a valet driver is allowed to operate the vehicle 10 as a result of successful authentication will be described as an example.

The management apparatus 400 can be regarded as a management apparatus for a valet parking service. The management apparatus 400 is managed by a manager (service provider), or the like, of the valet parking service. The management apparatus 400, for example, manages information about service users (user information), information about valet drivers (valet driver information), and parking lot information, executes a user registration process, executes a process of accepting the use of the service, selects valet driver candidates appropriate to an attribute desired by a service user, and provides the valet driver candidates to the service user. The management apparatus 400 operates as an issuing device that issues authentication information for enabling the operation of the vehicle 10 with the use of the valet driver terminal 200B. A valet driver is a person registered in the management apparatus 400 as a valet driver who parks the vehicle 10 in place of a service user. A valet driver may be a general person (individual) or may be an employee of a chauffeur service provider different from the service provider. A valet driver may be an employee employed by the service provider as a valet driver. In the following description, the case where a valet driver is a general person or an employee of a chauffeur service provider will be exemplified.

### Flow of Valet Parking Service

The flow of the valet parking service will be described with reference to FIG. 1. A person who desires to use the valet parking service accesses the management apparatus 400 with the use of the user terminal 200A, and performs user registration to become a membership (service user) of the valet parking service (<1> in FIG. 1). After that, when the service user submits a request for the valet parking service, the service user operates the user terminal 200A, accesses the management apparatus 400, and applies for the use of the service (<2> in FIG. 1). In the application procedure, application information regarding a contract for the valet parking service (a date and time of use, a pickup place, a parking lot, a service fee, the bearing of a parking fee, and the like) is exchanged between the management apparatus 400 and the user terminal 200A. In this information exchange, desired attribute information indicating a desired attribute of a valet driver is provided (transmitted) from the user terminal 200A to the management apparatus 400, information indicating valet driver candidates selected based on the desired attribute information is provided (transmitted) from the management apparatus 400 to the user terminal 200A, and information indicating a valet driver selected from among the valet driver candidates is transmitted from the user terminal 200A to the management apparatus 400 (<3> in FIG. 1).

As a result of the information exchange, when the valet driver is determined and the contract for the valet parking service is concluded, the management apparatus 400 transmits valet driving instructions including the pickup place, information about the vehicle 10, and the like, to the valet driver terminal 200B of the determined valet driver (<4> in FIG. 1). The selected valet driver goes to the pickup place of the vehicle 10 in accordance with the valet driving instructions, and picks up the vehicle 10.

At the time of the pickup, the operation of the vehicle 10 by the valet driver is enabled. That is, the valet driver terminal 200B receives authentication information for enabling the operation of the vehicle 10 from the management apparatus 400 (<5> in FIG. 1), and supplies the authentication information to the key unit 100 of the vehicle 10. With the supplied authentication information, the key unit 100 acts as an electronic key in the smart key system, and the valet driver is allowed to unlock the vehicle 10, start the engine, and drive the vehicle 10. In this way, the valet parking service according to the present embodiment does not require a service user to hand over an electronic key to a valet driver, so the service user may be present or not present in a pickup place. The valet driver drives the vehicle 10, moves the vehicle 10 to a parking lot to park the vehicle 10, and parks the vehicle 10 in the parking lot. Upon completion of parking, for example, the enabled operation of the vehicle 10 by the valet driver is cancelled by invalidating authentication information. After that, the service user goes to the parking lot in which the vehicle 10 has been parked, and collects the vehicle 10.

Hereinafter, the details of devices that implement the valet parking service will be described.

### Configuration of Mobile Terminal

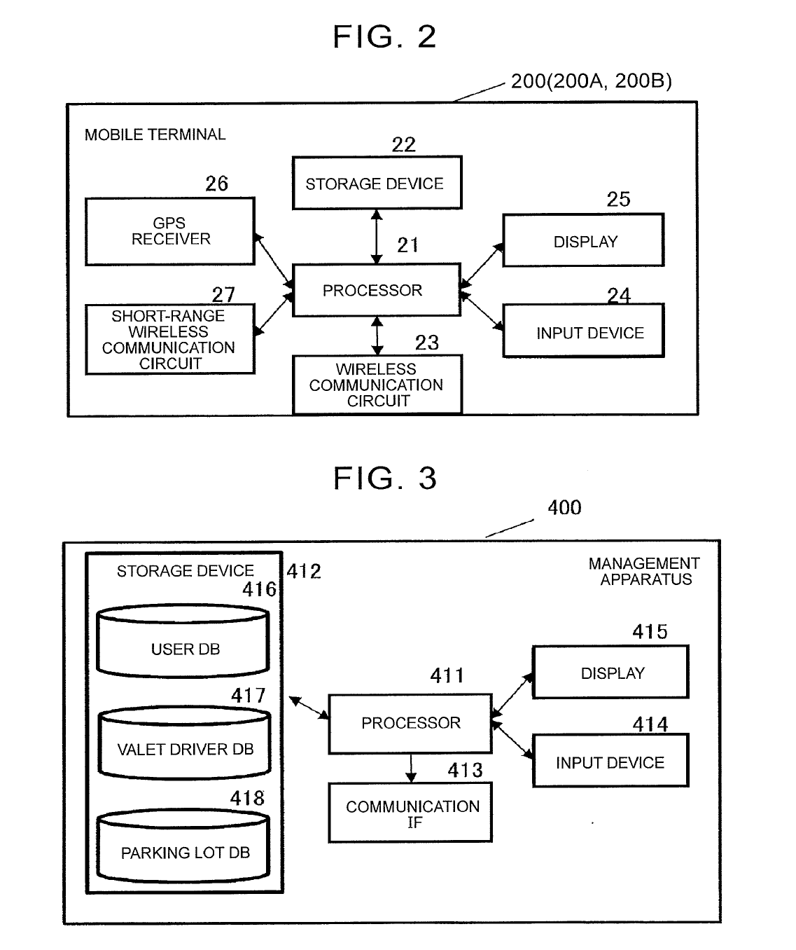

FIG. 2 shows an example of the configuration of the mobile terminal 200 that is usable as the user terminal 200A or the valet driver terminal 200B. The mobile terminal 200 includes a processor 21, a storage device 22, a wireless communication circuit 23, an input device 24, a display 25, a global positioning system (GPS) receiver 26, and a short-range wireless communication circuit 27.

The storage device 22 includes a main storage device and an auxiliary storage device. The main storage device is used as a storage area for programs and data, an expansion area for programs, a work area for programs, a buffer area for communication data, and the like. The main storage device is formed of a random access memory (RAM) or a combination of a RAM and a read-only memory (ROM). The auxiliary storage device is used as a storage area for data and programs. The auxiliary storage device includes a nonvolatile storage medium. Examples of the nonvolatile storage medium include a hard disk, a solid-state disk (SSD), a flash memory, and an electrically erasable programmable read-only memory (EEPROM).

The wireless communication circuit 23 governs wireless communication that conforms to a wireless communication system (such as LTE and wireless LAN (Wi-Fi)) that is supported by the mobile terminal 200. Examples of the input device 24 include a key, a button, a pointing device, and a touch panel. The input device 24 is used to input information. Examples of the display 25 include a liquid crystal display. The display 25 displays information or data. The GPS receiver receives signals from GPS satellites, and calculates the location of the mobile terminal 200. The short-range wireless communication circuit 27 governs short-range communication that conforms to predetermined short-range wireless communication standards (such as Near field communication (NFC), Bluetooth (registered trademark) low energy (BLE), Ultra wideband (UWB), and Zigbee).

Examples of the processor 21 include a central processing unit (CPU). The processor 21 causes the mobile terminal 200 to operate as the user terminal 200A or the valet driver terminal 200B by executing various programs stored in the storage device 22.

### Configuration of Management Apparatus

FIG. 3 shows an example of the configuration of the management apparatus 400. A personal computer, a general-purpose information processing device, such as a workstation, or an exclusive information processing device, such as a server machine, is applied as the management apparatus 400. The management apparatus 400 includes a processor 411, a storage device 412, a communication interface (communication IF) 413, an input device 414, and a display 415.

Similar devices as those described as the examples of the processor 21, the storage device 22, the input device 24, and the display 25 are applicable as the processor 411, the storage device 412, the input device 414, and the display 415. However, depending on a difference in application or intended use, devices different in performance from those that are applied to the mobile terminal 200 are applied to the management apparatus 400.

The communication IF 413 governs communication processing. For example, a network interface card (NIC) may be applied as the communication IF 413. The communication IF 413 transmits or receives data or information to or from the user terminal 200A and the valet driver terminal 200B via the network 1. The processor 411 causes the management apparatus 400 to operate as the management apparatus for a valet parking service and the issuing device for issuing authentication information by executing various programs stored in the storage device 412.

At least part of processes that are executed by the processor 21 or the processor 411 may be executed by a processor other than the CPU, such as a DSP and a GPU, an exclusive or general-purpose integrated circuit, such as an application specific integrated circuit (ASIC) and a field programmable gate array (FPGA), or a combination of the processor and the integrated circuit. The combination is called, for example, a microcontroller (MCU), a system-on-chip (SoC), a system LSI, a chip set, or the like.

### Description of DBs

By way of example, a user database (user DB) 416, a valet driver database (valet driver DB) 417, and a parking lot database (parking lot DB) 418 are stored in the storage device 412.

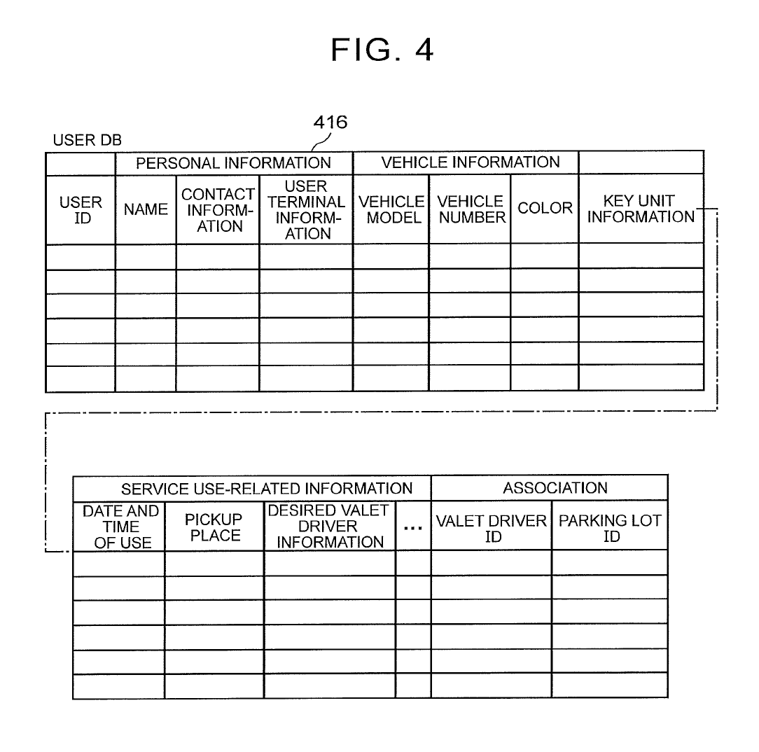

The user DB 416 stores user information. FIG. 4 shows an example of the data structure of the user DB 416. User personal information, vehicle information, key unit information, and service use-related information are stored in the user DB 416 in association with a user ID. The user ID is the identification information of a service user. A user ID should be unique information among user IDs of users. The personal information includes the name, contact information (such as address, phone number, and mail address), user terminal information, and the like, of a service user. The user terminal information is information for communication of the management apparatus 400 with the user terminal 200A. Examples of the user terminal information include the internet protocol (IP) address and media access control (MAC) address of the user terminal 200A. Personal information other than the above-illustrated information may be further included. Personal information is stored, for example, at the time of user registration; however, personal information may be stored at other timing.

The vehicle information includes information for visually identifying a vehicle 10. Examples of the vehicle information include a vehicle model, a vehicle number (vehicle identification number plate), and the color of a vehicle (for example, a paint color, that is, a body color). The vehicle information may include a feature that is useful for a valet driver to find a vehicle 10, in addition to the above-described information. Information indicating a feature can include information that contributes to identifying a vehicle 10. Examples of the information that contributes to identifying a vehicle 10 include option parts (such as a roof carrier, a roof box, and a spare tire), special paint (paint in different colors, or a drawn image), and a sticker. The vehicle information is stored in the user DB 416, for example, at the time of applying for the use of the service. Alternatively, the vehicle information may be stored at the time of user registration. Registration of vehicle information is optional.

The key unit information is information regarding the key unit 100 mounted on a vehicle 10. The key unit information is used to issue authentication information that matches the key unit 100. In the present embodiment, the above-described personal information and vehicle information are registered by a service user. Instead, part or all of those pieces of information may be registered in place of a service user by a dealer of the vehicle 10 before delivery or at a factory at which the vehicle 10 is assembled.

The service use-related information is information regarding the use of the service. The service use-related information includes a date and time of use, a pickup place of a vehicle 10, and the like. The date and time of use indicates, for example, scheduled pickup time of a vehicle 10. The date and time of use may include scheduled collection time of a vehicle 10. Information indicating the attribute of a valet driver that a service user desires (referred to as desired valet driver information) is stored as the service use-related information. Furthermore, a valet driver ID associated with a user ID of a service user is allowed to be registered in the user DB 416 as information indicating association (correspondence relation) of a service user with a valet driver. A parking lot ID indicating a parking lot associated with a service user (user ID) is allowed to be registered in the user DB 416. When a search for a corresponding valet driver ID or parking lot ID with a user ID as a search key is desired, the corresponding valet driver ID or parking lot ID is registered in the user DB 416.

The attribute that can be included in the desired valet driver information may be any information as long as the information can be a reference at the time when a user considers a valet driver to whom a request is submitted. Examples of the attribute include a pickup place of a vehicle, a current location of a vehicle, a current location of a valet driver, a distance between a valet driver and a pickup place or current location of a vehicle, a location area of a valet driver, a time required for a valet driver to reach a pickup place, an age of a valet driver, sex of a valet driver, an appearance of a valet driver, a background (birthplace, hobby, professional skill, academic background, business career, qualification, driving experience, and the like) of a valet driver, whether a valet driver smokes, a service fee of a valet driver, word-of-mouth (a rumor about a reputation of things) count of a valet driver, a rating of a valet driver, an insurance coverage amount (upper limit coverable amount at the time of an accident) of a valet driver, a birthplace of a valet driver, a hobby of a valet driver, and whether a valet driver has a gold driver's license.

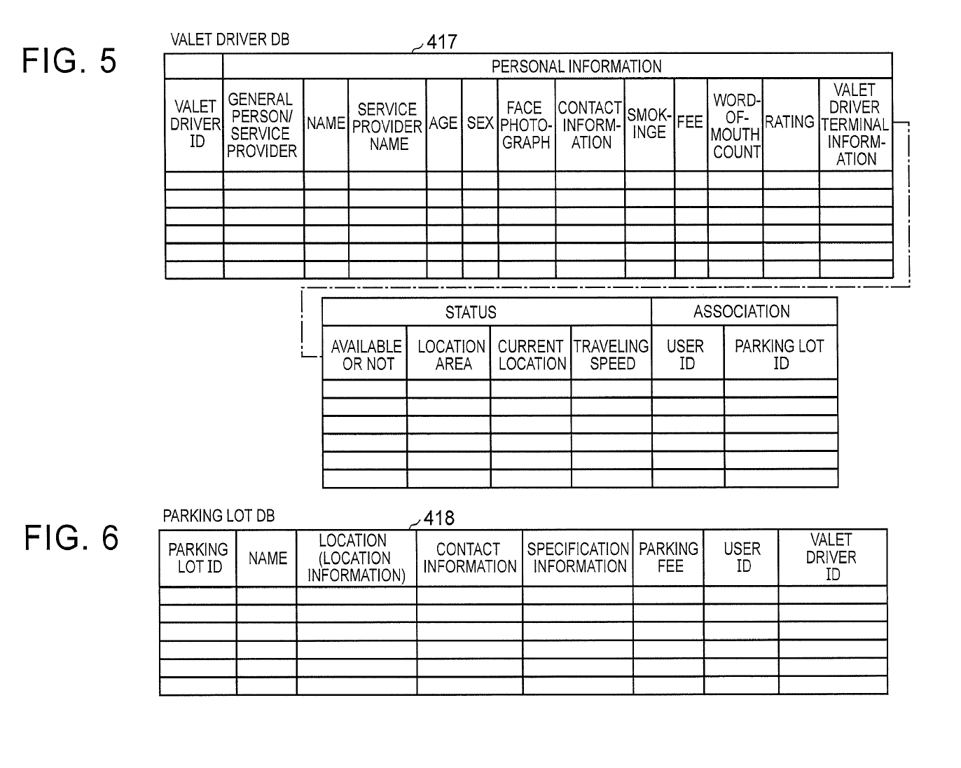

FIG. 5 shows an example of the data structure of the valet driver DB 417. For example, a valet driver type, valet driver personal information, and status information are stored in the valet driver DB 417 in association with a valet driver ID. The valet driver ID is the identification information of a valet driver. A valet driver ID should be unique information among valet driver IDs of valet drivers. The valet driver type indicates whether a valet driver is a general person or an employee of a chauffeur service provider. The valet driver personal information includes the name of a valet driver, a service provider (the name of a chauffeur service provider to which a valet driver belongs), an age of a valet driver, sex of a valet driver, a face photograph of a valet driver, contact information (address, phone number, mail address, or the like) of a valet driver, whether a valet driver smokes, a service fee of a valet driver, word-of-mouth count of a valet driver, a rating of a valet driver, and valet driver terminal information. The contact information of a valet driver is used to individually contact a valet driver. The valet driver terminal information includes the identification information of a valet driver terminal 200B, such as the IP address and MAC address of a valet driver terminal 200B. The valet driver terminal information is used to carry out communication between the management apparatus 400 and a valet driver terminal 200B. Other than the above, although not shown in the drawing, the personal information includes an insurance coverage amount, and a background (birthplace, hobby, professional skill, academic background, business career, qualification, and the like).

The status information includes at least one of whether a valet driver is available, a location area of a valet driver, a current location of a valet driver, and a moving speed of a valet driver by way of example. The status information may further include an information item. Whether a valet driver is available is information indicating whether a valet driver is able to undertake valet parking. Whether a valet driver is available is set to “not available (NG)” when the valet driver is out of business hours or has been already dispatched; otherwise, whether a valet driver is available is set to “available (OK)”. The location area indicates a geographical area in which the current location of a valet driver (valet driver terminal 200B) is included. The geographical area may be an administrative section, an area partitioned by a manager in accordance with an appropriate rule, or an area inside a circle of a predetermined radius with the center that coincides with the location of a valet driver terminal 200B. The location information indicates the location information of a valet driver terminal 200B. The moving speed indicates an average moving speed of a valet driver, obtained from the location information. The number of samples, which is used to calculate an average moving speed, may be selected as needed. The location area, the location information, and the moving speed are used to narrow down valet drivers. For example, when a pickup place (pickup location) of a vehicle 10 is provided, a distance between a current location and the pickup location is obtained, and the distance is divided by a moving speed. Thus, a pickup place (pickup location) of a vehicle 10 is used to calculate a time required to reach the pickup location. Furthermore, as illustrated in FIG. 5, a user ID or parking lot ID associated with a valet driver ID may be registered in the valet driver DB 417. When a search for a corresponding user ID or parking lot ID with a valet driver ID as a search key is desired, the corresponding user ID or parking lot ID is registered in the valet driver DB 417.

FIG. 6 illustrates the data structure of the parking lot DB 418. The parking lot DB 418 stores the name of a parking lot, the address (the location information of a parking lot) of a parking lot, the contact information of a manager of a parking lot, information indicating the above-described specifications of a parking lot (specification information), information indicating a parking fee, and the like, in association with a parking lot ID that is a unique ID provided for each parking lot. However, not all these information items are indispensable, and information other than these information items may be stored. Examples of the specifications of a parking lot include the type of a parking lot (flat or multistory), the size of a parking space in a parking lot, whether there is space for opening and closing a door, and the required height of a parking space. A sense of satisfaction of a service user with the use of the service may be increased by selecting a parking lot having specifications that the service user allows or desires. In addition, as illustrated in FIG. 6, a user ID or valet driver ID associated with a parking lot ID may be registered in the parking lot DB 418. When a search for a corresponding user ID or valet driver ID with a parking lot ID as a search key is desired, the corresponding user ID or valet driver ID is registered in the parking lot DB 418. A correspondence relation (association) among a user ID, a valet driver ID, and a parking lot ID may be managed in a database or table, other than the user DB 416, the valet driver DB 417, or the parking lot DB 418.

### Operation Example at Time of User Registration

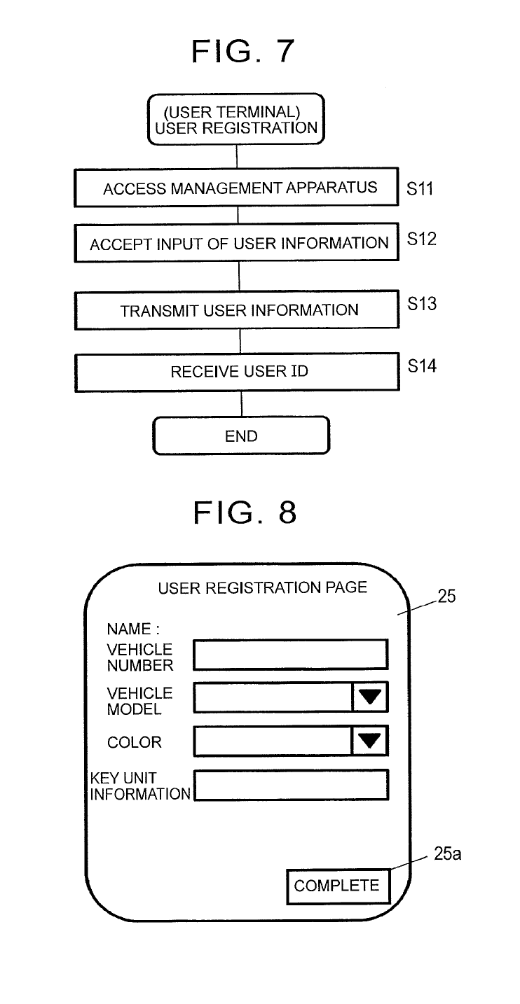

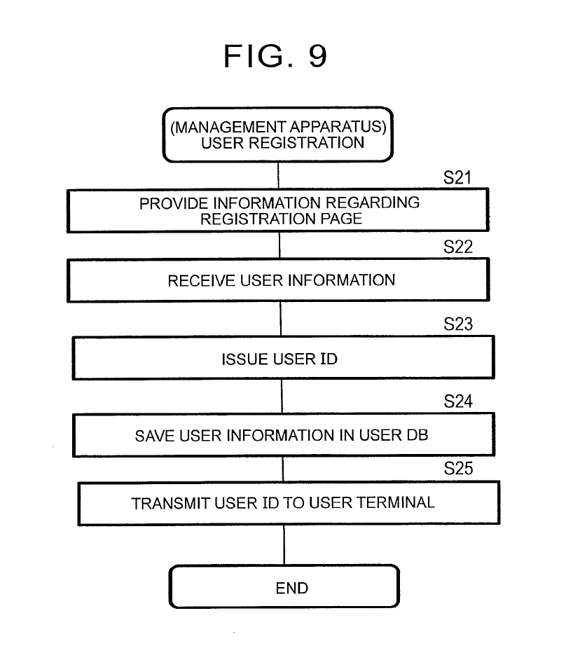

Next, an operation example of the user terminal 200A and management apparatus 400 at the time of user registration (at the time of new registration: <1> in FIG. 1) of a service user will be described. FIG. 7 is a flowchart that shows the flow of a process at the time of user registration with the use of the user terminal 200A, and shows a process that is executed by the processor 21 (FIG. 2) of the user terminal 200A. FIG. 8 shows an example of a user registration page. FIG. 9 is a flowchart that shows the flow of a process that is executed by the management apparatus 400 at the time of user registration.

As shown in FIG. 7, when a user desires user registration, the user accesses the management apparatus 400 (Web site (also referred to as operating site) for a valet parking service) with the use of the user terminal 200A (S11). In S11, the user terminal 200A establishes a communication session with the management apparatus 400 via the network 1, and then the user terminal 200A is able to transmit or receive information and data with the use of the communication session. The management apparatus 400 provides information regarding a new registration page in response to the access from the user terminal 200A (S21 of FIG. 9). The user terminal 200A is able to display a page (Web page), based on page information that is transmitted from the operating site, on the display 25 by executing a browser among programs. An exclusive application that is installed onto the user terminal 200A may be used to display a page for information from the operating site.

As shown in FIG. 8, the user registration page that is displayed on the display 25 contains input fields for personal information, such as a name, vehicle information, such as a vehicle number, a vehicle model, and a color, and key unit information. The processor 21 accepts input of the pieces of information (S12). However, information items that are inputable with the use of the user registration page are not limited to the above-described items, and may be selected as needed. As the required matters are input to the input fields and then a complete button 25a is depressed, the processor 21 transmits the input user information to the management apparatus 400 (S13). As the processor 411 of the management apparatus 400 receives the user information (S22), the processor 411 issues a user ID (S23), and saves the user information in the user DB 416 in association with the user ID (S24). For example, a source IP address of a packet used to transmit the user information is registered in the user DB 416 as user terminal information. The management apparatus 400 transmits the user ID to the user terminal 200A (S25). The processor 21 of the user terminal 200A receives the user ID, and saves the user ID in the storage device 22 (S14). In this way, user registration completes. The user ID saved in the user terminal 200A is attached to information that is transmitted to the management apparatus 400, and is used to store the information in a corresponding record of the user DB 416.

### Operation Example at Time of Application for Service

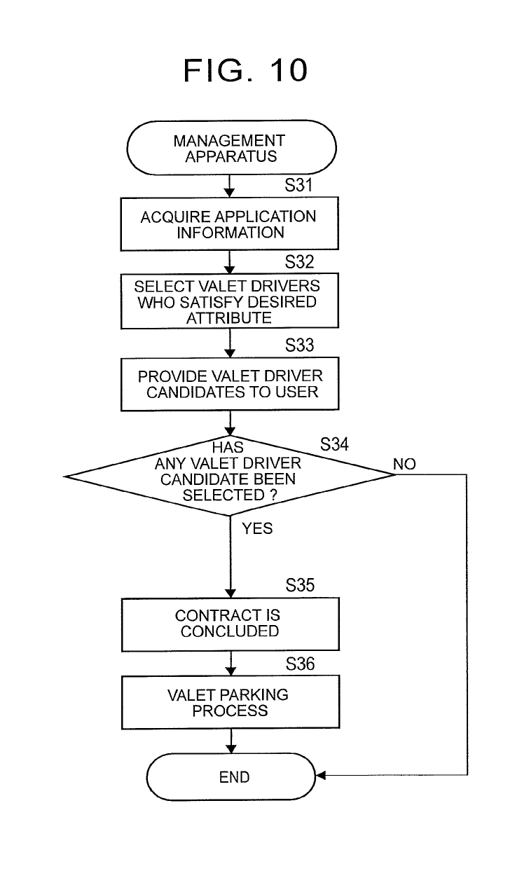

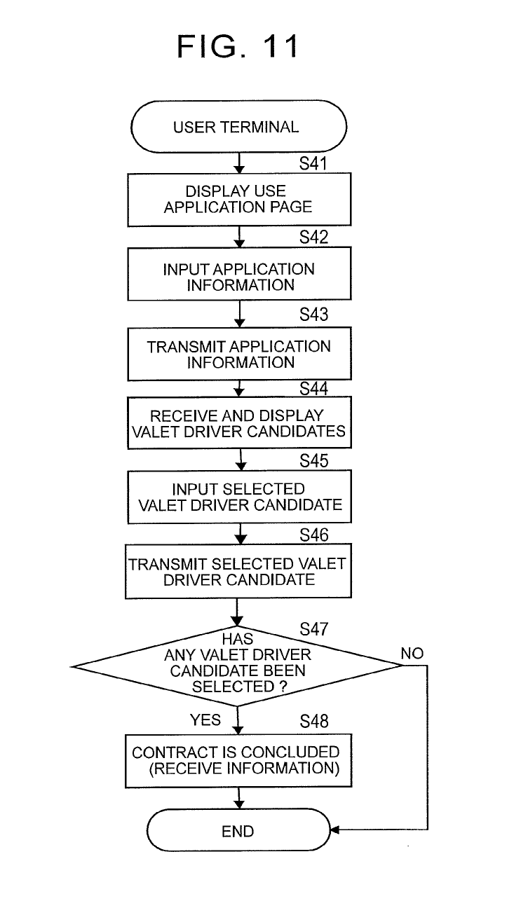

Next, an operation example of the management apparatus 400 at the time of application for the service (<2> in FIG. 1) will be described. FIG. 10 shows the flow of a process that is executed by the management apparatus 400 from application for the use of the valet parking service to a valet parking process (output of valet driving instructions). FIG. 11 shows the flow of a process that is executed by the user terminal 200A.

In S31, (the processor 411 of) the management apparatus 400 acquires application information from a service user. That is, as the user terminal 200A accesses the management apparatus 400 (operating site) and logs into the management apparatus 400 with the user ID, the management apparatus 400 transmits information of a use application page for the valet parking service to the user terminal 200A. The processor 21 of the user terminal 200A displays the use application page on the display 25 (S41 in FIG. 11).

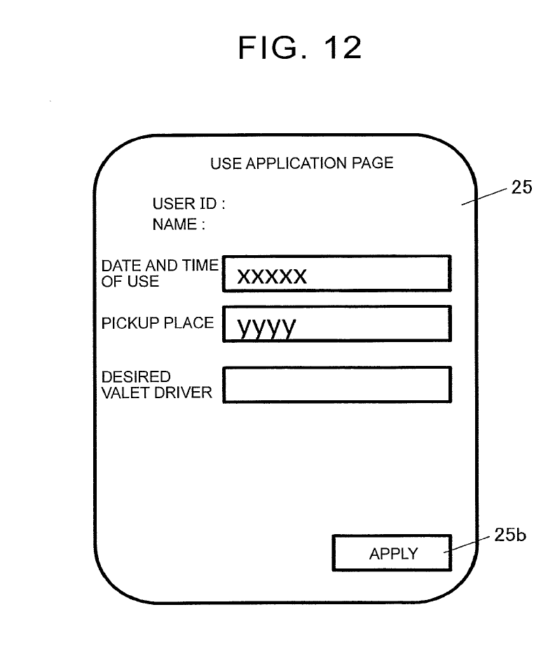

FIG. 12 shows a display example of the use application page. The use application page contains the input fields of a date and time of use (pickup date and time), pickup place, and desired valet driver information of the service user, and an application button 25b. A date and time of pickup of the vehicle 10 is input as a date and time of use. The use application page may further contain scheduled collection time of the vehicle 10. The pickup place may be information about a place in which the vehicle 10 is stopped for pickup, or may be information indicating a point at which the vehicle 10 is stopped and that is narrower than the place (pickup location). When a pickup place has been input (designated), a representative point of the place is used as a pickup location.

Information indicating the attribute of a valet driver that the service user wants to ask for valet parking is input to the input field of the desired valet driver information. The number of attributes to be input may be one or more. In selecting (searching for) a valet driver, logical operation, such as AND operation (AND) of attributes to be input and OR operation (OR) of attributes to be input, may be designated. Of course, the use application page may be configured to provide a plurality of choices provided in advance for the attribute of a valet driver in check boxes or a pull-down menu as an input field of the desired information, and allow the service user to select a desired attribute from among the plurality of choices. However, input of the desired valet driver information is not indispensable. The application button 25b is a button for providing an instruction to complete input of application information and transmit the application information.

The user inputs application information, such as a date and time of use, a pickup place, and desired valet driver information, with the use of the use application page, and depresses the application button 25b. After that, the user terminal 200A accepts the application information input with the use of the use application page (S42 in FIG. 11), and transmits the application information to the management apparatus 400 (S43 in FIG. 11). In this way, the processor 411 of the management apparatus 400 acquires application information. Alternatively, desired valet driver information may be input with the use of the user registration page, or the like, at the time of user registration.

In S32, the processor 411 of the management apparatus 400 selects a valet driver who satisfies the attribute desired by the service user. That is, the processor 411 consults the valet driver DB 417, and detects a record of a valet driver having an attribute that matches with the desired valet driver information in the application information. When a plurality of records has been detected, all the records may be set for valet driver candidates. However, a predetermined upper limit number is provided for the number of records in advance, and, when the number of records, which exceeds the upper limit number, has been detected, the records of the upper limit number are extracted as valet driver candidates in accordance with a predetermined rule.

When no desired valet driver information has been input, the processor 411, for example, extracts valet drivers present within the same location area as the pickup place as valet driver candidates. Alternatively, the processor 411 extracts a predetermined number of valet drivers selected in ascending order of distance between a current location and a pickup place of the vehicle 10 as valet driver candidates. Alternatively, the processor 411 extracts a predetermined number of valet drivers selected in ascending order of arrival time to a pickup place as valet driver candidates. Instead of a pickup place, the current location of the vehicle 10 may be used. The user terminal 200A may acquire the current location of the vehicle 10 with the use of the GPS, and transmit the current location to the management apparatus 400. Alternatively, the current location of the vehicle 10 may be input as the desired valet driver information.

When the desired valet driver information has been input, valet drivers having an attribute that matches with an attribute, desired by the service user and indicated by the desired valet driver information, are selected as valet driver candidates. For example, when “sex: female” is desired, a predetermined number of female valet driver candidates are extracted. Alternatively, when “non-smoking” is desired as the desired valet driver information, a predetermined number of non-smoking valet driver candidates are extracted. Alternatively, when, for example, “cheap service fee” is desired as the desired valet driver information, a predetermined number of valet driver candidates are extracted in ascending order of service fee. When the desired valet driver information includes a plurality of attributes, AND operation or OR operation between the attributes is carried out in accordance with designation of the service user or a rule set in advance, and appropriate valet drivers are extracted from the valet driver DB 417. AND operation or OR operation between extracting valet drivers having attributes that match with desired attributes and extracting valet drivers based on a pickup place or a current location of the vehicle 10 may be carried out.

In S33, the processor 411 generates information of a valet driver selection page (not shown) for setting the valet drivers indicated by the records detected or extracted in S32 for valet driver candidates from among which the service user selects, and transmits the information of the valet driver selection page to the user terminal 200A. The processor 21 of the user terminal 200A displays the valet driver selection page on the display 25 with the use of the information of the valet driver selection page (S44 in FIG. 11).

On the valet driver selection page, the face photograph of each valet driver candidate and their attributes are displayed. At least the attribute input by the service user as the desired valet driver information is displayed as the attributes. Of course, an attribute other than the input attribute may be displayed. The service user makes input to select a valet driver (input a selected result), to whom a request for valet parking is submitted, from among the plurality of valet driver candidates, and finalizes the input of the selected result (S45 in FIG. 11). However, the service user may make input of the fact that no valet driver candidate is selected as a selected result and finalize the input. The processor 21 transmits a response including information indicating the finalized selected result to the management apparatus 400 (S46 in FIG. 11).

The processor 21 determines whether any one of the valet driver candidates has been selected in the selected result (S47 in FIG. 11). When the processor 21 determines that no valet driver candidate has been selected, the processor 21 determines that no contract is concluded, and ends the process. In contrast, when the processor 21 determines that any one of the valet driver candidates has been selected, the processor 21 receives the fact that the contract is concluded and information about the valet driver from the management apparatus 400, and displays those pieces of information on the display 25 (S48 in FIG. 11). Thus, the service user is allowed to submit a request for valet parking to the desired valet driver, and recognize that the request has been accepted.

The processor 411 of the management apparatus 400 determines whether the selected result included in the response includes a valet driver candidate selected by the service user (S34). When no valet driver candidate has been selected as a selected result, the processor 411 determines that no contract is concluded, and ends the process. At this time, the processor 411 may transmit, to the user terminal 200A, information indicating that no contract is concluded. When the processor 411 determines that the valet driver candidate has been selected, the processor 411 advances the process to S35.

In S35, the processor 411 of the management apparatus 400 transmits, to the user terminal 200A, information that the contract for the valet parking service is concluded. When no valet driver matches an attribute desired by the service user, the processor 411 may transmit, to the user terminal 200A, valet driver candidates extracted in accordance with a predetermined rule and the fact that no valet driver matches the attribute desired by the service user. When the service user approves any one of the valet driver candidates as a valet driver, the processor 411 may issue a bonus (such as a coupon and a reward) for the service user.

In S36, the processor 411 executes the valet parking process. The processor 411 associates the valet driver ID of the selected valet driver with the user ID of the service user. For example, the processor 411 registers the correspondence relation between the valet driver ID and the user ID in at least one of the user DB 416 and the valet driver DB 417. The DB to which the correspondence relation is registered depends on which one of the user ID, the valet driver ID, and both the user ID and the valet driver ID is used as a search key. For example, the valet driver ID associated with the user ID is registered in the user DB 416. When a parking lot is determined in advance under the contract, the processor 411 associates the user ID of the service user with the parking lot ID of the parking lot that is used to park the vehicle 10 of the service user. That is, the processor 411 registers the parking lot ID associated with the user ID in the user DB 416. At this time, the processor 411 may also register a correspondence relation between the user ID and the parking lot ID in the parking lot DB 418. The processor 411 may register the corresponding user ID and valet driver ID in the parking lot DB 418. The processor 411 may register the parking lot ID corresponding to the valet driver ID in the valet driver DB 417. The processor 411 transmits valet driving instructions on the vehicle 10 to the valet driver terminal 200B with the use of the valet driver terminal information corresponding to the valet driver ID (<4> in FIG. 1).

The valet driving instructions include user information (the name of a user, contact information, vehicle information, key unit information, a date and time of use, and a pickup place) corresponding to the user ID associated with the valet driver ID. When a parking lot is determined in advance, the valet driving instructions further include parking lot information corresponding to the parking lot ID. The valet driver is allowed to go to a pickup place or receive issuance of authentication information with the use of the user information included in the valet driving instructions that are received by the valet driver terminal 200B. The valet driver is also allowed to drive the vehicle 10 to the parking lot in place of the service user with the use of the parking lot information received by the valet driver terminal 200B. For example, the valet driver is able to set a parking lot indicated by parking lot information for a destination of a car navigation system of the valet driver terminal 200B or vehicle 10, drive the vehicle 10 in accordance with instructions from the car navigation system, and move the vehicle 10 to the parking lot.

### Process in Valet Driver Terminal

As the valet driver terminal 200B receives valet driving instructions, the valet driver learns that the valet driver was selected as the valet driver for parking the vehicle 10, and goes to the pickup place of the vehicle 10 with the use of the information included in the valet driving instructions. The valet driver may go on foot or may go by a traveling vehicle (including a motorcycle and a bicycle) or another transportation means. The vehicle of the valet driver may be driven by the valet driver or a fellow occupant. For example, it is desirable that the valet driver goes to a pickup place with a fellow occupant by a traveling vehicle, parks the vehicle 10 in place of a service user, and is picked up by the fellow occupant with the traveling vehicle. The valet driver may receive, with the valet driver terminal 200B, the location of the vehicle 10, which the management apparatus 400 receives from the user terminal 200A, and may go to a pickup place with reference to the location of the vehicle 10.

When the valet driver has found the vehicle 10 in the pickup place, the valet driver operates the valet driver terminal 200B to transmit a request to issue authentication information to the management apparatus 400 (<5> in FIG. 1). The valet driver terminal 200B is able to obtain the address of the management apparatus 400 by learning the source address of the valet driving instructions. Alternatively, the management apparatus 400 may designate a destination address of a request to issue authentication information.

As the management apparatus 400 receives the issuance request, the management apparatus 400 consults the key unit information of the service user in the user DB 416, acquires authentication information (for example, stored in the storage device 412 in advance) corresponding to the key unit information, and transmits the authentication information to the valet driver terminal 200B (<5> in FIG. 1). The wireless communication circuit 23 of the valet driver terminal 200B receives the authentication information as enabling data from the management apparatus 400 via the network 1. When the processor 21 of the valet driver terminal 200B transmits the authentication information received from the management apparatus 400 to the key unit 100 (onboard unit), the key unit 100 acts as an electronic key. Thus, door lock of the vehicle 10 is released, and the engine is able to start when an engine start button provided in the vehicle 10 is depressed. That is, the vehicle 10 is placed in an operable state.

The valet driver opens the door of the vehicle 10, starts the engine, and heads for the destination (the parking lot for the vehicle 10) by driving the vehicle 10. As the valet driver parks the vehicle 10 in the parking lot, the valet driver gets out of the vehicle 10, and performs a predetermined invalidation process. As a result of the invalidation process, the key unit 100 stops acting as an electronic key, the operable state of the vehicle 10 is cancelled, and the vehicle 10 is locked. Thus, the valet driver is not able to unlock the vehicle 10 and drive the vehicle 10 again.

In the above description, the valet driver terminal 200B transmits an issuance request after the valet driver reaches a pickup place. Alternatively, after the valet driver terminal 200B has received valet driving instructions, the valet driver terminal 200B may transmit an issuance request at appropriate timing and then receive authentication information. In addition, in the present embodiment, after the management apparatus 400 receives an issuance request, the management apparatus 400 transmits authentication information to the valet driver terminal 200B. Alternatively, it is conceivable that receiving an issuance request is omitted and the management apparatus 400 transmits authentication information together with valet driving instructions.

In the above-described operation of the management apparatus 400, the processor 411 operates as a determination unit that determines a valet driver, selected by a service user from among a plurality of valet driver candidates, as a valet driver to whom a request to park the vehicle 10 in place of the service user is submitted. The processor 411 also operates as an extraction unit that extracts a plurality of valet driver candidates based on any one of a pickup place of the vehicle 10 and a current location of the vehicle 10. The processor 411 also operates as an extraction unit that extracts valet drivers each having an attribute that matches with desired valet driver information indicating an attribute desired by a service user, as a plurality of valet driver candidates. The communication IF 413 operates as a communication unit for carrying out communication with the user terminal 200A or the valet driver terminal 200B. The processor 411 and the communication IF 413 operate as a transmission unit that transmits a plurality of valet driver candidates to the user terminal 200A.

### Lock/Unlock System Including Key Unit

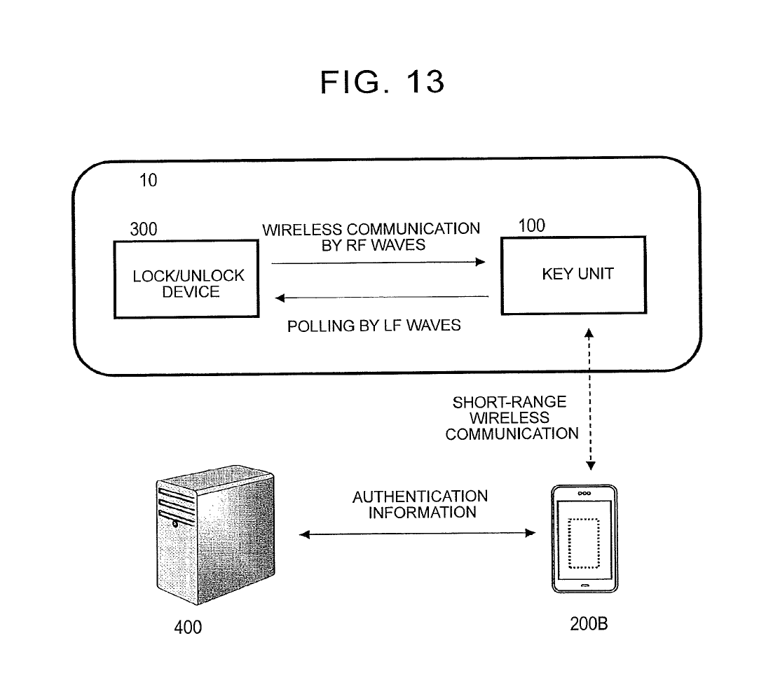

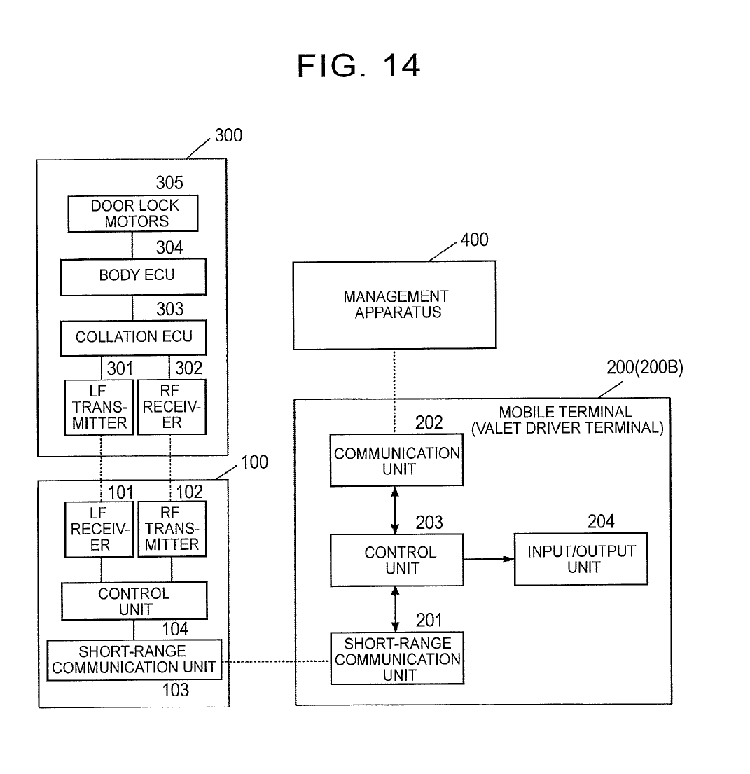

An example of a lock/unlock system including the key unit 100 that locks or unlocks the vehicle 10 will be described with reference to FIG. 13 and FIG. 14. As shown in FIG. 13, the lock/unlock system includes the key unit 100, the lock/unlock device 300, the valet driver terminal 200B, and the management apparatus 400. The key unit 100 and the lock/unlock device 300 are mounted on the vehicle 10. In the lock/unlock system, the key unit 100 includes a wireless interface similar to that of the electronic key (mobile device) of the smart key system. When the key unit 100 carries out communication with the already-existing lock/unlock device 300, it is possible to lock or unlock the vehicle 10 without using a physical key. The key unit 100 carries out short-range wireless communication with the valet driver terminal 200B, and determines whether the key unit 100 acts as an electronic key of the vehicle 10 based on the result of authentication of the valet driver terminal 200B. The valet driver is allowed to lock or unlock the vehicle 10 by operating the valet driver terminal 200B from the outside of the vehicle 10.

### System Configuration

As shown in FIG. 14, the lock/unlock device 300 locks or unlocks the doors of the vehicle 10 in response to a lock signal or unlock signal that is transmitted from an electronic key (hereinafter, mobile device) held by a user (service user) of the vehicle 10 via radio-frequency (hereinafter, referred to as RF) waves. The lock/unlock device 300 also has the function of transmitting low-frequency (hereinafter, referred to as LF) waves for searching for the mobile device. Instead of the mobile device held by the user, the key unit 100 controls locking and unlocking of the vehicle 10 by transmitting RF waves to the lock/unlock device 300 and receiving LF waves from the lock/unlock device 300.

The lock/unlock device 300 includes an LF transmitter 301, an RF receiver 302, a collation ECU 303, a body ECU 304, and door lock motors 305. The LF transmitter 301 transmits low-frequency (for example, 100 kHz to 300 kHz) waves for searching (polling) for the key unit 100. The LF transmitter 301 is incorporated near, for example, a center console or a door handle in the cabin. The RF receiver 302 receives radio-frequency (for example, 100 MHz to 1 GHz) waves transmitted from the key unit 100. The RF receiver 302 is disposed in any place in the cabin.

The collation ECU 303 controls locking or unlocking of the vehicle 10 based on a signal (lock signal or unlock signal) transmitted from the key unit 100 via RF waves. The collation ECU 303 is formed of, for example, a microcomputer, or the like. In the following description, the lock signal and the unlock signal are collectively referred to as lock/unlock signal. The term “lock/unlock signal” means at least one of the lock signal and the unlock signal.

The collation ECU 303 authenticates that the lock/unlock signal from the key unit 100 is a signal transmitted from a proper device. For example, the collation ECU 303 determines authentication based on whether the ID (hereinafter, key ID) of the electronic key included in the lock/unlock signal matches with the key ID prestored in a storage unit of the collation ECU 303. The collation ECU 303 transmits an unlock instruction or a lock instruction to the body ECU 304 based on the result of the authentication. The unlock instruction or the lock instruction is transmitted via an in-vehicle network, such as a controller area network (CAN).

The body ECU 304 is a computer that controls the body of the vehicle 10. The body ECU 304 unlocks or locks the vehicle 10 by controlling the door lock motors 305 based on an unlock instruction or lock instruction received from the collation ECU 303. The door lock motors 305 are actuators that lock or unlock the doors (not only passenger doors and a rear gate but also a trunk lid) of the vehicle 10. The door lock motors 305 operate based on a signal from the body ECU 304.

The key unit 100 authenticates the valet driver terminal 200B by carrying out short-range wireless communication with the valet driver terminal 200B, and transmits a lock/unlock signal with the use of RF waves based on the authentication result. The key unit 100 includes an LF receiver 101, an RF transmitter 102, a short-range communication unit 103, and a control unit 104 as an example. The LF receiver 101 receives a polling signal transmitted from the lock/unlock device 300 via LF waves. The LF receiver 101 has an antenna for receiving LF waves (hereinafter, LF antenna). The RF transmitter 102 transmits a lock/unlock signal to the key unit 100 via RF waves.

The short-range communication unit 103 carries out communication with the valet driver terminal 200B. The short-range communication unit 103 carries out communication within a short range (to such an extent that communication is available between the inside of a vehicle cabin and the outside of the vehicle cabin) with the use of predetermined wireless communication standards. The short-range communication unit 103 carries out data communication based on BLE as an example. BLE is low-power communication standards with Bluetooth (registered trademark). BLE has such a characteristic that pairing is not required between devices and it is possible to immediately start communication when an intended device is detected.

The control unit 104 carries out short-range wireless communication with the valet driver terminal 200B via the short-range communication unit 103. The control unit 104 executes control for authenticating the valet driver terminal 200B, and control for transmitting a lock/unlock signal based on an authentication result. The control unit 104 includes, for example, a processor and a memory. The processor implements various functions by executing a control program for controlling the key unit 100. The control program is stored in the memory. For example, the control unit 104 implements the function of receiving a polling signal transmitted from the lock/unlock device 300 as LF waves via the LF receiver 101, the function of transmitting a lock/unlock signal as RF waves to the lock/unlock device 300 via the RF transmitter 102, the function of processing communication with the valet driver terminal 200B via the short-range communication unit 103, the function of generating a lock/unlock signal when authentication of the valet driver terminal 200B is successful, and the like.

The control unit 104 executes an authentication process for the valet driver terminal 200B based on authentication information included in a lock request or unlock request (hereinafter, collectively referred to as lock/unlock request) transmitted from the valet driver terminal 200B. The control unit 104 compares authentication information stored in the memory with the authentication information transmitted from the valet driver terminal 200B, and determines that authentication is successful when these pieces of authentication information have a predetermined relationship. When both pieces of authentication information do not have the predetermined relation, the control unit 104 determines that authentication has failed. When authentication of the valet driver terminal 200B is successful, the lock/unlock signal generated in response to the request received from the valet driver terminal 200B is transmitted to the lock/unlock device 300 via the RF transmitter 102. Hereinafter, as needed for description, authentication information that is stored in the key unit 100 is referred to as device authentication information, and authentication information that is transmitted from the valet driver terminal 200B is simply referred to as authentication information.

The key unit 100 transmits the ID (key ID) of an electronic key to the lock/unlock device 300 together with a lock/unlock signal.

The valet driver terminal 200B will be described. When the processor 21 loads and executes programs stored in the storage device 22, the valet driver terminal 200B functions as a device that executes processes or operations of a short-range communication unit 201, communication unit 202, control unit 203, and input/output unit 204. The short-range communication unit 201 corresponds to the short-range wireless communication circuit 27. The short-range communication unit 201 carries out communication with the key unit 100 with the use of the same communication standards as the short-range communication unit 103. The communication unit 202 corresponds to the wireless communication circuit 23. The communication unit 202 connects the valet driver terminal 200B to the network 1, and governs communication with the management apparatus 400, or the like. The communication unit 202 carries out communication with another device (such as the management apparatus 400) via the network 1 by using a mobile communication service, such as 3G and LTE.

The control unit 203 corresponds to the processor 21. The control unit 203, for example, executes a process of generating a lock/unlock request, a process of acquiring the above-described authentication information, a process of transmitting a lock/unlock request and authentication information to the key unit 100, and the like. In addition to these processes, the control unit 203 further executes a process for rewriting a control program that is stored in the storage device of the key unit 100, as will be described later. The control unit 203 makes an interaction with a valet driver via the input/output unit 204. The input/output unit 204 corresponds to the input device 24 and the display 25. The input/output unit 204 accepts input operation made by the valet driver, and provides information to the valet driver.

The control unit 203 displays an operation page on the input/output unit 204, and generates an unlock request or a lock request in response to an operation made by the valet driver. For example, the control unit 203 outputs an icon for unlocking the doors, an icon for locking the doors, and the like, on a touch panel display, and generates an unlock request or a lock request based on an operation made by the valet driver. The operation that is made by the valet driver is not limited to an operation via a touch panel display. For example, the operation may be, for example, an operation made via a hardware switch, or the like.

The control unit 203 executes a process of acquiring authentication information from the management apparatus 400. The authentication information is not information for the lock/unlock device 300 to authenticate the key unit 100. The authentication information is information for the key unit 100 to authenticate the valet driver terminal 200B. Specifically, the control unit 203 transmits a signal that makes a request to issue authentication information together with information that identifies the valet driver terminal 200B to the management apparatus 400 via the communication unit 202. The management apparatus 400 that has received this signal acquires authentication information unique to the valet driver terminal 200B, and transmits the acquired authentication information to the valet driver terminal 200B. Thus, an operation for unlocking the vehicle 10 is enabled on the valet driver terminal 200B. When the valet driver terminal 200B has no authentication information, a lock operation and an unlock operation on the operation page are disabled. Authentication information that the valet driver terminal 200B acquires may be an invariant key or may be a one-time key. In any case, device authentication information corresponding to the authentication information is stored in the key unit 100 in advance.

### Invalidation (Cancellation of Operable State of Vehicle 10)

An operable state of the vehicle 10 is cancelled by the valet driver as follows. For example, the management apparatus 400 invalidates authentication information issued for the valet driver terminal 200B. As long as it is possible to make the valet driver not to be able to operate the vehicle 10 again after completion of parking of the vehicle 10 with the use of the valet driver terminal 200B, the specific details of the process of invalidating authentication information is not specifically limited.

Invalidation of authentication information is achieved, for example, when the management apparatus 400 executes the following processes. However, an invalidation method can apply a method other than the above as long as a valet driver is not allowed to unlock or drive the vehicle after the valet driver completes valet parking.

(1) An instruction to delete the authentication information is provided to the valet driver terminal 200B.
(2) An instruction to set an invalid flag for the authentication information is provided to the valet driver terminal 200B. In this case, the valet driver terminal 200B does not transmit the authentication information while the invalid flag is set.
(3) An instruction to rewrite an expiration date of the authentication information to a past date and time is provided to the valet driver terminal 200B. The valet driver terminal 200B deletes authentication information of which the expiration date has passed.
(4) The fact that the authentication information is invalid and an instruction to prohibit transmission of invalid authentication information are provided to the valet driver terminal 200B.
(5) The management apparatus 400 carries out communication with the key unit 100, and provides an instruction to the key unit 100 that the authentication information is invalid and is not accepted.
(6) The management apparatus 400 carries out communication with the key unit 100, and provides an instruction to the key unit 100 that the authentication information from the valet driver terminal 200B is not accepted.
(7) Other than the above, it is conceivable that the authentication information is manually deleted from the valet driver terminal 200B without any communication of the management apparatus 400.

### First Alternative Embodiment of Lock/Unlock System

In the above-described one example of the lock/unlock system, the vehicle 10 is unlocked by the lock/unlock device 300 when the authentication process is successful in the key unit 100. Alternatively, the process in the key unit 100 may be executed in the lock/unlock device 300 instead. That is, the lock/unlock device 300 may include a control unit (ECU) for authenticating authentication information received from the valet driver terminal 200B, and the control unit may transmit an unlock instruction or a lock instruction to the body ECU 304 via the in-vehicle network, such as the CAN, when authentication of the valet driver terminal 200B is successful. With this configuration, in a simple configuration in which no key unit 100 is provided, a valet driver is allowed to place the vehicle 10 in an operable state.

### Second Alternative Embodiment of Lock/Unlock System

In the above-described one example of the lock/unlock system, the valet driver terminal 200B receives authentication information as enabling data for enabling the vehicle 10 from the management apparatus 400, and, when the valet driver terminal 200B is authenticated based on the authentication information, a lock/unlock signal is transmitted from the key unit 100 to the lock/unlock device 300, and the vehicle 10 is locked or unlocked. The authentication information does not need to include information for authenticating the valet driver terminal 200B, and the authentication information may include information of a key ID for unlocking or locking the vehicle 10 instead. In this case, the valet driver terminal 200B receives authentication information including a key ID from the management apparatus 400, and transmits the received key ID to the lock/unlock device 300 together with a lock/unlock signal. The lock/unlock device 300 compares the received key ID with the key ID prestored in the lock/unlock device 300. When the received key ID matches with the prestored key ID, the lock/unlock device 300 locks or unlocks the vehicle 10. The key ID may be encrypted and transmitted or received between the valet driver terminal 200B and the management apparatus 400 or lock/unlock device 300. The management apparatus 400 may generate a one-time key by, for example, encrypting a key ID with time information in accordance with a predetermined algorithm. In the lock/unlock device 300, the received one-time key should be decoded by a method corresponding to the algorithm of the management apparatus 400, and should be compared with the key ID prestored in the lock/unlock device 300. A one-time key may be transmitted from the management apparatus 400 to a rental management server (not shown), and then may be transmitted from the rental management server to the valet driver terminal 200B. In any case, the valet driver terminal 200B invalidates a one-time key by deleting the one-time key as a predetermined time elapses from reception of the one-time key. By having authentication information include a one-time key that is generated from a key ID and time information, the management apparatus 400 is able to generate temporary valid authentication information and transmit the authentication information to the valet driver terminal 200B each time of valet parking.

### Third Alternative Embodiment of Lock/Unlock System

In the above-described one example of the lock/unlock system, the management apparatus 400 may transmit, to the valet driver terminal 200B, authentication information for the valet driver terminal 200B, corresponding to fixed authentication information unique to the key unit 100 or may transmit, to the valet driver terminal 200B, a key ID prestored in the lock/unlock device 300 of the vehicle 10. The management apparatus 400 may generate new authentication information and issue the new authentication information for the valet driver terminal 200B each time the management apparatus 400 receives a request for authentication information from the valet driver terminal 200B. In this case, the management apparatus 400 should store device authentication information for the key unit 100, corresponding to new authentication information for the valet driver terminal 200B, in the key unit 100 via an onboard communication device (not shown) communicable with the network 1 to which the valet driver terminal 200B is connected. In this case, the key unit 100 should be connected to the onboard communication device through the CAN, or the like. The management apparatus 400 may generate new authentication information based on time information and identification information that identifies the vehicle 10, and may pass over the new authentication information and the time information to the valet driver terminal 200B. In this case, the key unit 100 should also generate new authentication information with a method corresponding to the algorithm of the management apparatus 400. The valet driver terminal 200B should transmit the new authentication information and the time information to the key unit 100, and get authentication.

### Leaving Parking Lot

The service user goes to the parking lot in which the vehicle 10 has been parked by the valet driver, and collects the vehicle 10 by driving the vehicle 10 to leave the parking lot. With regard to leaving a parking lot, there are a case (a) in which a service user pays a parking fee and a case (b) in which a service provider pays a parking fee. When a service user pays a parking fee, the service user should go to the parking lot, pay the parking fee, and drive the vehicle 10 to leave the parking lot. In contrast, when a service provider pays a parking fee, the following operation is conceivable. For example, a service user has a predetermined code read by a parking fee adjustment machine provided in a parking lot. The predetermined code is, for example, a code that indicates a service provider or a valet driver. The predetermined code may be held in an IC card that is provided from the service provider to a service user or may be downloaded by the user terminal 200A from the management apparatus 400, or the like. The predetermined code is associated with a parking fee, and the manager of the parking lot collects the parking fee from the service provider. Instead of a service provider, a valet driver may pay a parking fee.

As an optional service, a service for providing not only valet parking but also a service for driving the vehicle 10 to leave a parking lot and driving the vehicle 10 up to a desired place of a service user in place of the service user may be provided. In this case, authentication information held in the valet driver terminal 200B may be reused without invalidating the authentication information. Alternatively, the valet driver terminal 200B may transmit an issuance request again, and may acquire authentication information from the management apparatus 400 again.

### Advantageous Effects of Embodiment

According to the embodiment, the management apparatus 400 receives, from the user terminal 200A, desired valet driver information indicating a desired valet driver to whom a service user wants to ask for valet parking, extracts from the valet driver DB 417 a predetermined number of valet drivers each having an attribute that matches with the desired valet driver information, and transmits the predetermined number of valet drivers to the user terminal 200A as a plurality of valet driver candidates. Thus, the plurality of valet driver candidates appropriate for the desired valet driver information are provided to the service user, so the service user is allowed to select and finalize a valet driver, to whom a request to park the vehicle 10 in place of the service user is submitted, from among the plurality of valet driver candidates. Thus, since the service user is allowed to submit a request to park the vehicle 10 in place of the service user to the valet driver having an attribute desired by the service user, the service user is allowed to conclude a contract for the valet parking service with a sense of safety and a sense of satisfaction. Since it is possible to designate an attribute of a person to whom a service user desires to submit a request before contract, usability of the valet parking service is improved. In the embodiment, a service user is allowed to select a valet driver from among valet driver candidates before contract. Instead, a service user may be allowed to select a valet driver from among valet driver candidates after contract. In this case as well, it is possible to provide a sense of safety and a sense of satisfaction to a service user on the valet parking service.

### Alternative Embodiment of Management Apparatus

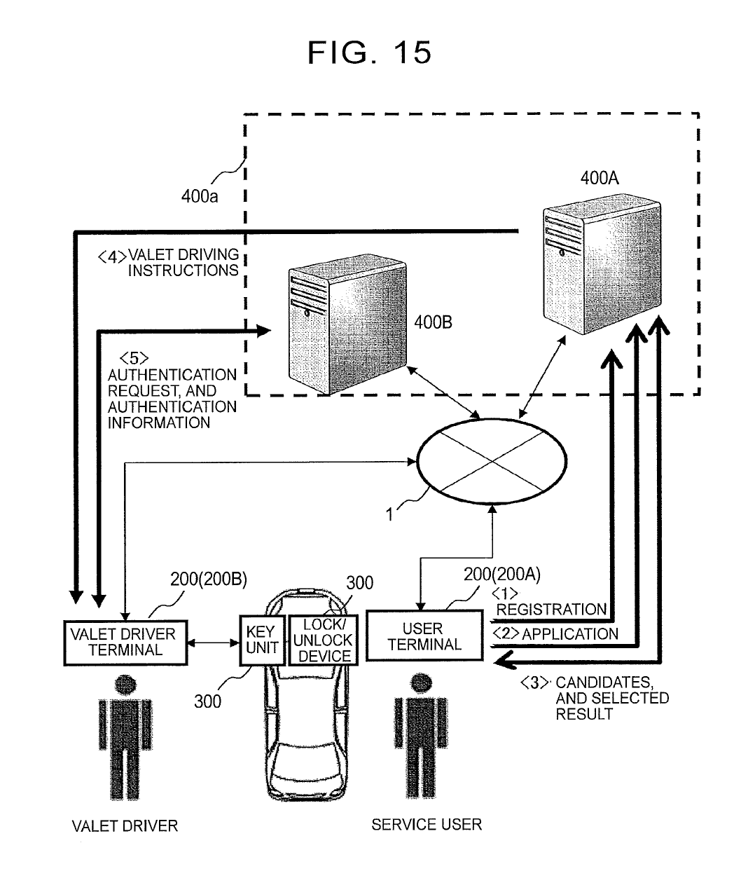

FIG. 15 shows an alternative embodiment of the management apparatus 400 shown in FIG. 1. A management apparatus 400a shown in FIG. 15 includes a first server device 400A and a second server device 400B. The first server device 400A executes a process of operating as the management apparatus for a valet parking service within the process that is executed by the management apparatus 400. The second server device 400B executes a process of operating as the issuing device for issuing authentication information within the process that is executed by the management apparatus 400.

In <4> of FIG. 15, the first server device 400A incorporates information indicating a method of accessing the second server device 400B, such as the address of the second server device 400B, into valet driving instructions that are transmitted to the valet driver terminal 200B. The valet driver terminal 200B transmits a request to issue authentication information to the second server device 400B with the use of the address of the second server device 400B. The second server device 400B issues authentication information in response to the issuance request, and transmits the authentication information to the valet driver terminal 200B (<5> in FIG. 15).

According to the alternative embodiment of the management apparatus, the process of the management apparatus 400 is distributed between the first server device 400A and the second server device 400B without any burden on service users or valet drivers, so it is possible to distribute load between management of service users and management of authentication information. The user terminal 200A does not access the second server device 400B having authentication information, so it is possible to employ different security levels for the first server device 400A and the second server device 400B. For example, it is conceivable to reduce a process and time required to exchange information with the user terminal 200A by lowering the security level of the first server device 400A as compared to the security level of the second server device 400B.

In the above-described embodiment, the key unit 100 is caused to act as an electronic key with the use of the valet driver terminal 200B. The valet parking service according to the above-described embodiment may be implemented even when the vehicle of a service user is a vehicle on which no key unit 100 is mounted. In this case, the vehicle (physical key) should be directly handed over between the service user and a valet driver. The components according to the above-described embodiment may be combined as needed.

What is claimed is:

1. A management apparatus for a valet parking service, which manages a valet parking service that a valet driver parks a vehicle of a service user in place of the service user, the management apparatus comprising a transmission unit including a communication unit and a processor, the transmission unit being configured to transmit information, indicating a plurality of valet driver candidates available to park the vehicle in place of the service user, to a terminal of the service user together with information indicating an attribute of each of the plurality of valet driver candidates.

2. The management apparatus according to claim 1, wherein the processor is configured to, when the processor has received information indicating a valet driver candidate selected by the service user from among the plurality of valet driver candidates, determine the valet driver candidate selected by the service user as a valet driver to whom a request to park the vehicle in place of the service user is submitted.

3. The management apparatus according to claim 1, wherein the processor is configured to extract the plurality of valet driver candidates based on any one of a pickup place of the vehicle and a current location of the vehicle.

4. The management apparatus according to claim 1, wherein the processor is configured to extract valet drivers each having an attribute that matches with an attribute of a valet driver desired by the service user, as the plurality of valet driver candidates.

5. The management apparatus according to claim 1, wherein the attribute is at least one that is selected from among sex of a valet driver, an age of a valet driver, whether a valet driver smokes, an appearance of a valet driver, a background of a valet driver, a time required for a valet driver to reach a pickup place, and a service fee of a valet driver.

6. A use support method for a valet parking service, which uses a valet parking service that a valet driver parks a vehicle of a service user in place of the service user, the use support method comprising transmitting information, indicating a plurality of valet driver candidates available to park the vehicle in place of the service user, to a terminal of the service user together with information indicating an attribute of each of the plurality of the valet driver candidates.

7. The use support method according to claim 6, further comprising, when information indicating a valet driver candidate selected by the service user from among the plurality of valet driver candidates has been received, determining the valet driver candidate selected by the service user as a valet driver to whom a request to park the vehicle in place of the service user is submitted.

8. A non-transitory computer-readable recording medium comprising a program recorded on the recording medium, the program causing a computer of a management apparatus for a valet parking service that a valet driver parks a vehicle of a service user in place of the service user, to execute instructions for transmitting information, indicating a plurality of valet driver candidates available to park the vehicle in place of the service user, to a terminal of the service user together with information indicating an attribute of each of the plurality of the valet driver candidates.

9. The recording medium according to claim 8, wherein the program further causes the computer to execute instructions for, when information indicating a valet driver candidate selected by the service user from among the plurality of valet driver candidates has been received, determining the valet driver candidate selected by the service user as a valet driver to whom a request to park the vehicle in place of the service user is submitted.
